(19) United States
(12) Patent Application Publication
(10) Pub. No.: US 2008/0267464 A1
(43) Pub. Date: Oct. 30, 2008

(54) IMAGE PROCESSING APPARATUS, IMAGE PROCESSING METHOD, AND RECORDING MEDIUM RECORDED WITH PROGRAM THEREOF

(75) Inventor: Junichi Goda, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/105,697

(22) Filed: Apr. 18, 2008

(30) Foreign Application Priority Data
Apr. 26, 2007 (JP) 2007-117740

(51) Int. Cl. G06K 9/00

(52) U.S. Cl. 382/124

(57) ABSTRACT

The present invention provides a mechanism for re-registering a paper fingerprint that may change. A configuration for this includes: a extracting means that extracts a paper fingerprint of a sheet surface and coded information on the paper fingerprint; a means that decodes the coded information extracted by the extracting means; a matching means that matches paper fingerprint data decoded by the decoding means with data of the extracted paper fingerprint; and a re-registration prompting means that performs a display to prompt a re-registration based on a result of matching by the matching means.

### BACKGROUND OF THE INVENTION

1. Field of the Invention

The present invention relates to an image processing apparatus and an image processing method that can handle information on a paper fingerprint unique to a sheet of paper, and a recording medium recorded with a program that makes a computer execute the image processing method.

2. Description of the Related Art

There are official documents such as resident cards, insurance policies, or other confidential documents. With regard to the documents, it is important to authenticate originals. Due to an improvement in printing technology, such paper documents as mentioned above are now printed by image forming apparatuses such as printers and copiers, and simultaneously therewith, it has become necessary to prevent forgery using color scanners or color copiers.

As a technique for preventing forgery, a countermeasure has been adopted, such that a pattern such as a Copy-forgery-inhibited pattern is embedded when printing on a sheet of paper so that the Copy-forgery-inhibited pattern is printed so as to stand out when the sheet is copied. Moreover, adding a semiconductor component such as a non-contact IC or an RFID to a sheet of paper itself, writing data to authenticate the original in the semiconductor component, and recording information read from the semiconductor component by a scanner or a copier when the sheet is copied, to leave a history of the copying has also been performed. Or, by combination with user authentication, a process is performed such that copying cannot be performed unless authentication based on the information read from a semiconductor component and user authentication is performed.

Further, a process is also performed such that specific pattern information is embedded, when printing, in halftone that is poor in visibility for a user as invisible information, and a printing motion is stopped when a scanner or a copier has read the information in the case of copying.

However, adding semiconductor components or the like to sheets of paper results in an increase in the price of the sheets themselves. Moreover, it sometimes becomes necessary to use special hardware for the scanner or copier for the purpose of adding invisible information and responding to a non-contact IC, RFID, or the like, so that a problem of an increase in cost has existed. Moreover, there has been a problem that the invisible information can also be possibly forged by reading with a scanner or a copier.

In view of these problems, techniques using the fact that arrangement of fibers on the surface of a sheet of paper or the like serving as a recording medium differs sheet by sheet have been developed in recent years. Specifically, the surface of a recording medium such as a sheet of paper is read by a reading means such as a scanner or a copier, an arrangement pattern of fibers thus read (referred to as a paper fingerprint) or the like is converted to digital information as pattern data. The digital information is then recorded at the time of printing on the sheet of paper, in, for example, invisible halftone. This has led to a process of authenticating an original is being performed, when a recording medium such as a sheet of paper that has been printed once is again read for copying, by comparing pattern information which the sheet of paper itself has with pattern data converted to digital information that has been printed on the sheet of paper. In this case, using an already existing scanner, printer, or copier and modifying a section of software makes it possible to authenticate the original at a low cost.

### SUMMARY OF THE INVENTION

Although usage of such a paper fingerprint makes it possible to authenticate an original at a low cost, since the original itself is paper, it becomes folded or blotted and is worn with the elapse of time, and thus fiber pattern information which the sheet of paper itself has changes. Therefore, there is a possibility that matching of the paper fingerprint performed for authentication of the original results in a failure. For this reason, a system for re-registering paper fingerprint information is necessary, and it is desirable that a process for this re-registration is efficiently performed.

Moreover, in the case where paper fingerprint matching of the original has resulted in a failure, when a user that can register the original re-registers the paper fingerprint of the same original, matching time is prolonged and user convenience is spoiled if information including invalid information is used for matching of the paper fingerprint.

Therefore, in order to solve the problems described above, an image processing apparatus of the invention of the present application is configured specifically as follows.

In the first aspect of the present invention, there is provided an image processing apparatus comprising: an extracting means that extracts a paper fingerprint of a sheet surface and coded information on the paper fingerprint; a decoding means that decodes the coded information extracted by the extracting means; a matching means that matches paper fingerprint data decoded by the decoding means with data of the extracted paper fingerprint; and a re-registration prompting means that performs a display operation to prompt a re-registration based on a result of matching by the matching means.

In the second aspect of the present invention, there is provided an image processing apparatus comprising: an extracting means that extracts a paper fingerprint of a sheet surface and coded information on the paper fingerprint; an adding means that adds the coded information to the sheet surface; a registering means that registers a second paper fingerprint and second coded information different from a first paper fingerprint and first coded information; and a processing means that processes the first coded information so as to make the first coded information undeterminable when registration by the registering means is performed.

In the third aspect of the present invention, there is provided an image processing method comprising the steps of: extracting a paper fingerprint of a sheet surface and coded information on the paper fingerprint; decoding the coded information extracted in the extracting step; matching paper fingerprint data decoded in the decoding step with data of the extracted paper fingerprint; and prompting a re-registration by performing a display operation to prompt a re-registration based on a result of matching in the matching step.

In the forth aspect of the present invention, there is provided an image processing method comprising the steps of: extracting a paper fingerprint of a sheet surface and coded information on the paper fingerprint; adding the coded information to the sheet surface; registering a second paper fingerprint and second coded information different from a first paper fingerprint and first coded information; and processing the first coded information so as to make the first coded information undeterminable when registration is performed in the registering step.

In the fifth aspect of the present invention, there is provided an image processing program comprising the steps of: extracting a paper fingerprint of a sheet surface and coded information on the paper fingerprint; decoding the coded information extracted in the extracting step; matching paper fingerprint data decoded in the decoding step with data of the extracted paper fingerprint; and prompting a re-registration by performing a display operation to prompt a re-registration based on a result of matching in the matching step.

According to the present invention, it becomes possible to re-register a paper fingerprint in a paper fingerprint registration/matching system, and by making unnecessary information, that is, unmatchable coded information, unreadable, the time for matching can be reduced.

Further features of the present invention will become apparent from the following description of exemplary embodiments (with reference to the attached drawings).

### BRIEF DESCRIPTION OF THE DRAWINGS

FIG. 1 is a diagram showing the entire configuration of an image forming system according to a first embodiment of the present invention;

FIG. 2 is a diagram illustrating an external view of input/output devices of an image forming apparatus of the same embodiment;

FIG. 3 is a diagram showing the entire configuration of an image forming apparatus of the same embodiment;

FIG. 4 is a diagram conceptually showing tile data in the same embodiment;

FIG. 5 is a block diagram of a scanner image processing section in the same embodiment;

FIG. 6 is a block diagram of a printer image processing section in the same embodiment;

FIG. 7 is a diagram for explaining a copy screen of an operating section in the same embodiment;

FIG. 8 is a flowchart of a paper fingerprint information obtaining process in the same embodiment;

FIG. 9 is a flowchart of a paper fingerprint information matching process in the same embodiment;

FIG. 10A to FIG. 10C are diagrams showing examples of paper fingerprint information collecting positions in the same embodiment;

FIG. 11A to FIG. 11C are diagrams showing composition examples of code image data in the same embodiment;

FIG. 12 is a flowchart when a tab for a paper fingerprint information matching process is depressed in the same embodiment;

FIG. 13A to FIG. 13C are diagrams showing examples of a display screen of an operating section 12 in the paper fingerprint information matching process flow of FIG. 12;

FIG. 14 is a flowchart when a tab for a paper fingerprint information registering process is depressed in the same embodiment;

FIG. 15A to FIG. 15J are diagrams showing combining images to be combined on code image data in the same embodiment;

FIG. 16 is a flowchart of a re-registration process that is performed when paper fingerprint matching fails in the same embodiment;

FIG. 17A to FIG. 17C are diagrams showing documents to be scanned in a second embodiment of the present invention; and

FIG. 18 is a flowchart showing a processing method when a matching process command has been received in a third embodiment of the present invention.

### DESCRIPTION OF THE EMBODIMENTS

Hereinafter, best modes for carrying out the present invention will be described with reference to the drawings.

### <Printing System>

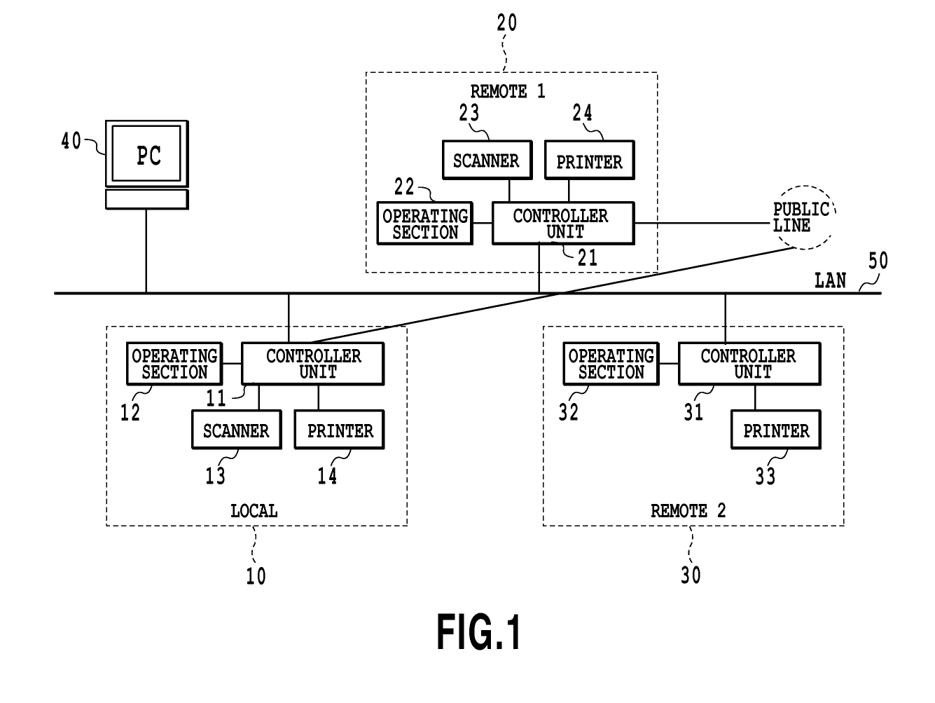

First, a first embodiment will be described in detail with reference to the drawings. FIG. 1 is a block diagram showing a configuration of a printing system according to an embodiment of the present invention.

Although a host computer 40 and three image forming apparatuses (10, 20, and 30) are connected to a LAN 50 in this system, there is no limitation to the number of connections of these in the printing system in accordance with the present invention. In addition, although a LAN has been applied as a connecting method in the present embodiment, the connecting method is not limited hereto. For example, another arbitrary network such as a WAN (public line), a serial transmission system such as USB, a parallel transmission system such as a Centronics interface and SCSI and the like can also be applied.

The host computer (hereinafter, referred to as a PC) 40 has a function of a personal computer. The PC 40 is capable of transmitting and receiving files or e-mails by using FTP or SMB protocol via the LAN 50 or WAN. Moreover, it is possible to issue a print command to the image forming apparatuses 10, 20, and 30 via a printer driver from the PC 40.

The image forming apparatuses 10 and 20 are apparatuses having the same configuration. The image forming apparatus 30 is an image forming apparatus with only a printing function and does not include a scanner section, which is included in the image forming apparatuses 10 and 20. Hereinafter, for simplification of description, the configuration of the image forming apparatus 10 will be described in detail while focusing attention thereon in the image forming apparatuses 10 and 20.

The image forming apparatus 10 is composed of a scanner section 13 serving as an image input device, a printer section 14 serving as an image output device, a controller 11 that takes charge of operation control of the image forming apparatus 10 as a whole, and an operating section 12 serving as a user interface (UI).

### <Image Forming Apparatus 10>

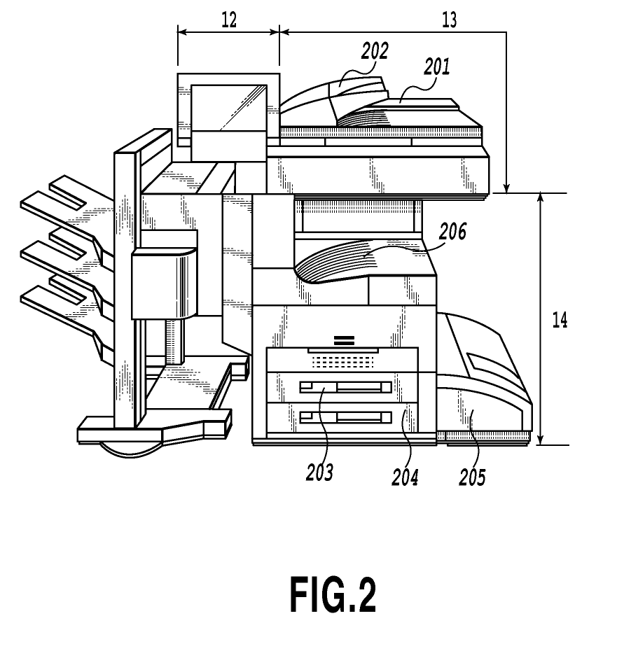

An external view of the image forming apparatus 10 is shown in FIG. 2.

The scanner section 13 has a plurality of CCDs. When these CCDs are different in sensitivity from each other, even if the respective pixels on a document are the same in density, it is recognized that the respective pixels have densities different from each other. Therefore, in the scanner section 13, a white plate (a uniformly white plate) is first exposure-scanned, and the amount of reflected light obtained by the exposure-scanning is converted to electrical signals and output to the controller 11.

As will be described later, a shading correcting section 500 within the controller 11 recognizes a difference in sensitivity of the respective CCDs based on electrical signals obtained from the respective CCDs. The shading correcting section 500 then uses the difference in sensitivity thus recognized to correct the values of electrical signals obtained by scanning an image on a document. Further, the shading correcting section 500 performs, upon receiving information concerning gain control from a CPU 301 within the controller 11 to be described later, gain control in accordance with the information. The gain control is used to control how the values of electrical signals obtained by exposure-scanning a document are assigned to luminance signal values of 0 to 255. This gain control allows converting the values of electrical signals obtained by exposure-scanning a document to high luminance signal values or to a low luminance signal values.

Next, the configuration for scanning an image on a document will be described.

The scanner section inputs a reflected light obtained by exposure-scanning an image on a document to the CCDs and thereby converts information on the image to electrical signals. Further, the scanner section converts the electrical signals to luminance signals of respective R, G, and B colors, and outputs the luminance signals to the controller 11 as image data.

Documents are set on a tray 202 of a document feeder 201. When a user instructs the start of reading from the operating section 12, the controller 11 gives a document reading instruction to the scanner section 13. Upon receiving the instruction, the scanner section 13 feeds the documents from the tray 202 of the document feeder 201 one at a time and performs a document reading operation. Here, the document may be read by a method for scanning a document by placing the document on an unillustrated glass surface and moving an exposure section, not by automatic feeding method using the document feeder 201.

The printer section 14 is an image forming apparatus that forms image data received from the controller 11 on a sheet of paper. In the present embodiment, electrophotographic system using a photoconductive drum or a photoconductive belt is used as an image forming method, however, the present invention is not limited hereto. For example, an inkjet method of ejecting ink from a minute nozzle array and printing the ink on a sheet of paper can also be applied. Moreover, the printer section 14 is provided with a plurality of paper cassettes 203, 204, and 205 that make it possible to select different sheet sizes or different sheet orientations. Sheets after printing are ejected to a paper output tray 206.

### <Controller 11>

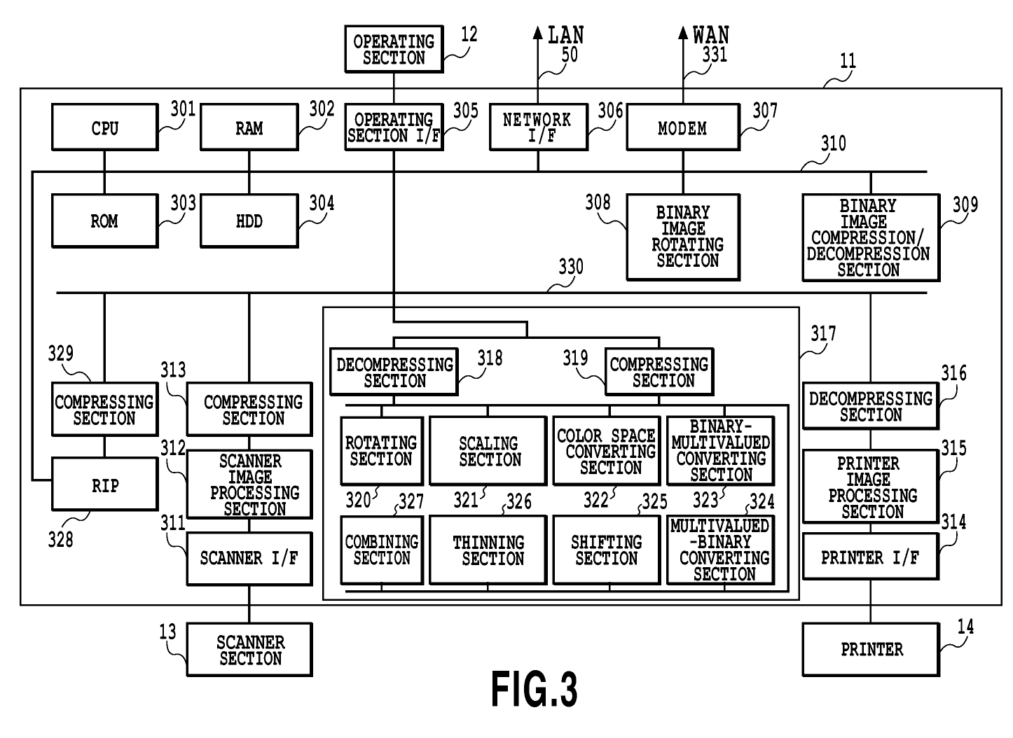

FIG. 3 is a block diagram for explaining the configuration of the controller 11 of the image forming apparatus 10 in greater detail.

The controller 11 is electrically connected to the scanner section 13 and the printer section 14 and is, on the other hand, connected to the PC 40, external apparatuses, and the like via the LAN 50 and WAN 331. This makes it possible to input and output image data and device information.

The CPU 301 comprehensively controls access to various devices connected therewith based on a control program or the like stored in a ROM 303 and also comprehensively controls various types of processing performed in the controller. A RAM 302 is a system work memory for the CPU 301 to operate and is also a memory to temporarily store image data. The RAM 302 is composed of a nonvolatile SRAM that holds stored contents even after power-off and a DRAM where contents stored therein are erased after power-off. The ROM 303 stores a boot program of the apparatus and the like. An HDD 304 is a hard disk drive, which is capable of storing system software and image data.

An operating section I/F 305 is an interface section for connecting a system bus 310 and the operating section 12. The operating section I/F 305 receives image data to be displayed in the operating section 12 from the system bus 310and outputs the image data to the operating section 12, and outputs information input from the operating section 12 to the system bus 310.

A network I/F 306 connects to the LAN 50 and the system bus 310 and inputs/outputs information. A modem 307 connects to the WAN 331 and the system bus 310 and inputs/outputs information. A binary image rotating section 308 changes the direction of image data before transmission. A binary image compression/decompression section 309 converts the resolution of image data before transmission to a predetermined resolution or a resolution matching other party capability. Also, for compression and decompression, well-known system such as JBIG, MMR, MR, and MH may be used. An image bus 330 is a transmission line for exchanging image data and is composed of a PCI bus or an IEEE 1394 bus.

A scanner image processing section 312 performs correction, processing, and editing on image data received from the scanner section 13 via a scanner I/F 311. Also, the scanner image processing section 312 determines whether the received image data is data of a color document or a black-and-white document, or a text document or a photographic document, and the like. Then, it attaches the determination result to the image data. Such collateral information is referred to as attribute data. Details of the process performed by the scanner image processing section 312 will be described later.

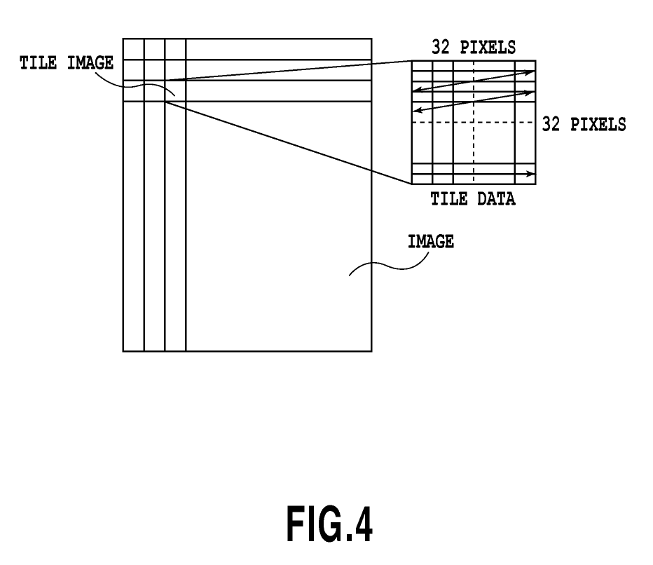

A compressing section 313 receives image data, and divides the image data into blocks each consisting of 32 pixels×32 pixels. Here, the image data consisting of 32 pixels×32 pixels is referred to as tile data. FIG. 4 conceptually shows the tile data. In a document serving as a paper medium before reading, an area corresponding to the tile data is referred to as a tile image. To the tile data, average luminance information in the block of 32 pixels×32 pixels and a coordinate position on the document of the tile image are added as header information. Further, the compressing section 313 compresses image data composed of a plurality of tile data. A decompressing section 316 decompresses the image data composed of a plurality of tile data and then develops into a raster, and transmits the data to a printer image processing section 315.

The printer image processing section 315 receives image data transmitted from the decompressing section 316 and applies image processing to the image data with referring to the attribute data annexed to the image data. The image data after image processing is output to the printer section 14 via a printer I/F 314. Details of the process performed by the printer image processing section 315 will be described later.

An image converting section 317 applies a predetermined conversion process to image data. The image converting section 317 is composed of the following processing sections.

A decompressing section 318 decompresses received image data. A compressing section 319 compresses received image data. A rotating section 320 rotates received image data. A scaling section 321 performs a resolution converting processing to convert the resolution of received image data, for example, from 600dpi to 200dpi. A color space converting section 322 converts a color space of received image data. The color space converting section 322 can perform a well-known background color removal processing using a predetermined conversion matrix or conversion table, a well-known LOG converting processing (a conversion from RGB to CMY), and a well-known output color correcting processing (a conversion from CMY to CMYK).

A binary-multivalued converting section 323 converts received binary gradationimage data to 256-step gradation image data. On the other hand, a multivalued-binary converting section 324 converts received 256-step gradation image data to binary gradation image data by a technique such as an error diffusion processing.

A combining section 327 combines received two pieces of image data to generate one piece of image data. When two pieces of image data are combined, a method for composition using an average of luminance values of corresponding pixels to be combined as a composite luminance value or a method for composition using a luminance value of a pixel higher in a luminance level as a luminance value of a pixel after composition is applied. Alternatively, a method for composition using a luminance value of a pixel lower in a luminance level as a luminance value of a pixel after composition can also be used. Furthermore, a method for determining a luminance value after composition by an OR operation, an AND operation, an exclusive OR operation, or the like of pixels to be combined can also be applied. All of these composition methods are widely known.

A thinning section 326 converts resolution by thinning out pixels of received image data and generates image data such as half, quarter, or one-eighth image data. A Shifting section 325 attaches margins to received image data or deletes margins from received image data.

A RIP 328 receives intermediate data generated based on PDL code data transmitted from the PC 40 or the like and generates multivalued bitmap data.

### <Scanner Image Processing Section>

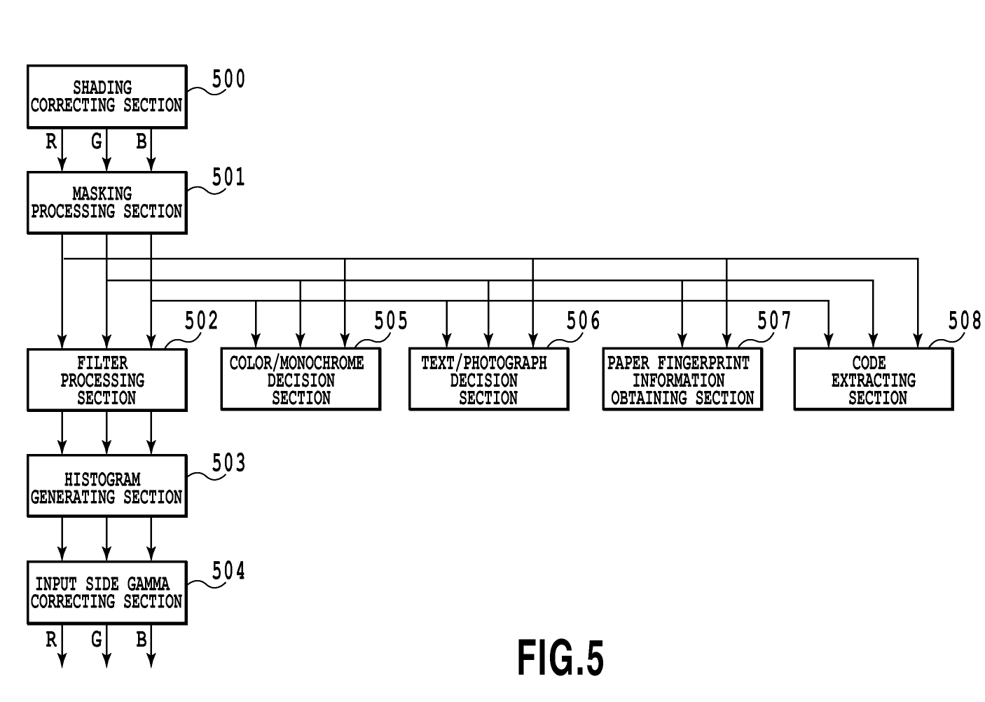

FIG. 5 shows an internal configuration of the scanner image processing section 312.

The scanner image processing section 312 receives image data consisting of R, G, and B luminance signals each having 8 bits. The shading correcting section 500 applies a shading correction to these luminance signals. The shading correction is, as described above, a processing to prevent the brightness of a document from false recognition due to unevenness in sensitivity of the CCDs. Further, as described above, the shading correcting section 500 can perform gain control in accordance with an instruction from the CPU 301.

Subsequently, the luminance signals are converted to standard luminance signals that do not depend on filter colors of the CCDs by a masking processing section 501.

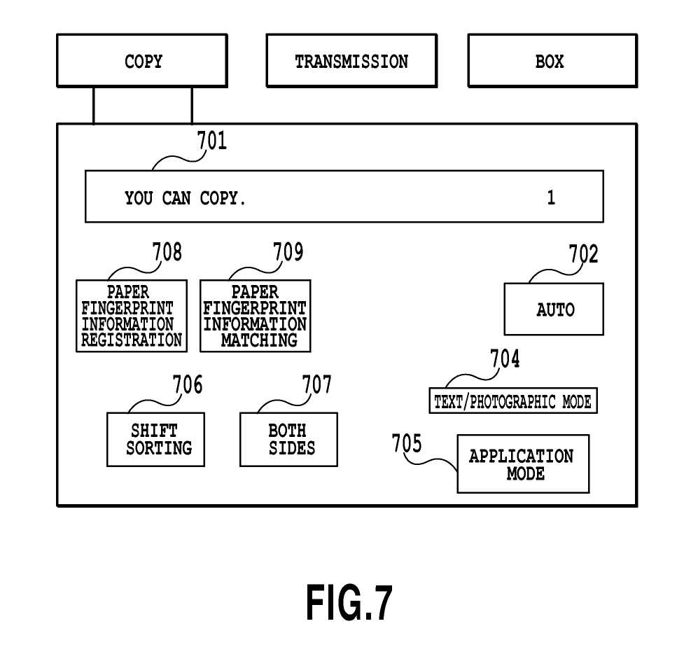

A filter processing section 502 arbitrarily corrects a spatial frequency of received image data. The processing section performs an operation process using, for example, a 7×7 matrix on the received image data. Meanwhile, in a copier or a multifunction apparatus, a text mode, a photographic mode, or a text/photographic mode can be selected as a copy mode by depressing a tab 704 in FIG. 7. When the text mode is selected by a user, the filter processing section 502 applies a filter for text onto the entire image data. When the photographic mode is selected by a user, the filter processing section 502 applies a filter for photograph onto the entire image data. When the text/photographic mode is selected, the filtering section 502 adaptively switches filters for each pixel in accordance with a text/photograph decision signal, which is part of the attribute data, to be described later. That is, whether the filter for photograph or the filter for text is applied is determined for each pixel. Also, the filter for photograph is set with a coefficient such that only a high-frequency component is smoothed. This is for making roughness of an image inconspicuous. On the other hand, the filter for text is set with a coefficient such that edge reinforcement is strongly performed. This is for sharpening the text.

A histogram generating section 503 samples luminance data of each pixel of received image data. More specifically, the histogram generating section 503 samples luminance data in a rectangular area, defined by a start point to an end point specified in a main scanning direction and a sub-scanning direction, respectively, at constant pitches in the main scanning direction and the sub-scanning direction. Then, the histogram generating section 503 generates histogram data based on the sampling result. The generated histogram data is used to estimate a background color level when performing a background color removal processing. An input side gamma correcting section 504 converts received data to luminance data having a nonlinear characteristic by using a table or the like.

A color/monochrome decision section 505 determines whether each pixel of received image data is chromatic color or achromatic color, and annexes the determination result to the image data as a color/monochrome decision signal, which is part of the attribute data.

A text/photograph decision section 506 determines whether each pixel of image data is a pixel that constitutes a text, a pixel that constitutes a halftone dot, a pixel that constitutes a text in halftone dots, or a pixel that constitutes a sold image based on a pixel value of each pixel and pixel values of peripheral pixels of each pixel. Also, the pixels that cannot be classified to any one of them are pixels constituting a white area. Then, the text/photograph decision section 506 makes the determination result accompany the image data as a text/photograph decision signal, which is part of the attribute data.

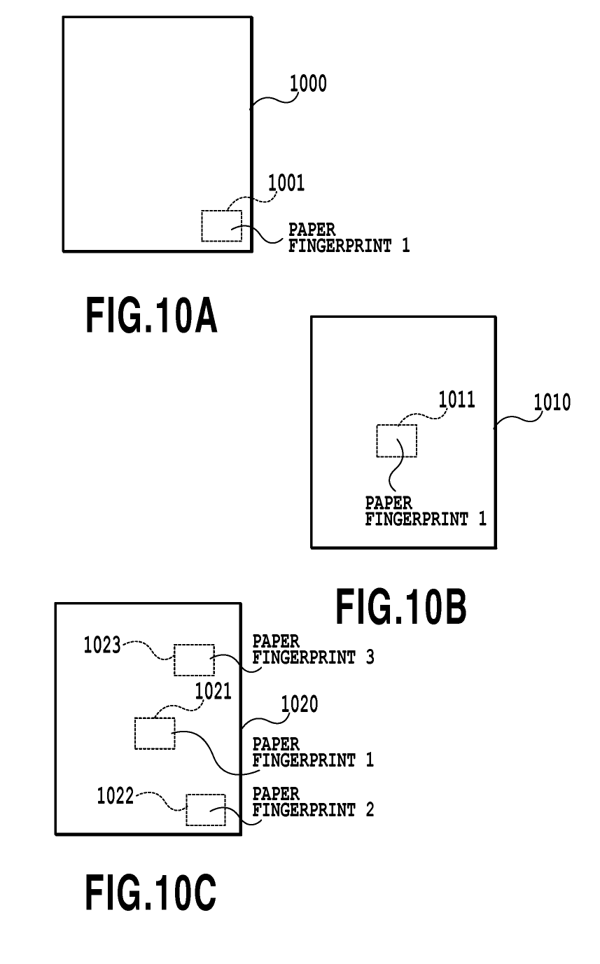

A paper fingerprint information obtaining section 507 obtains image data of a predetermined area in the RGB image data input from the shading correcting section 500. Here, examples of the predetermined area are shown in FIG. 10A to FIG. 10C. A sheet of paper 1000 is an A4 size sheet, and a paper fingerprint is picked up in an area 1 denoted by reference numeral 1001 in the sheet (FIG. 10A). The area is not specified to be at this position, but may be at a position different from the area 1 denoted by reference numeral 1001 in the sheet 1000, such as an area 1 denoted by reference numeral 1011 in a sheet 1010 (FIG. 10B). Moreover, as in a sheet of paper 1020, a fingerprint can be picked up not only at one spot but also at a plurality of spots, such as an area 1 denoted by reference numeral 1021, an area 2 denoted by reference numeral 1022, and an area 3 denoted by reference numeral 1023 (FIG. 10C). At this time, the position of the area in which a fingerprint was picked up is stored.

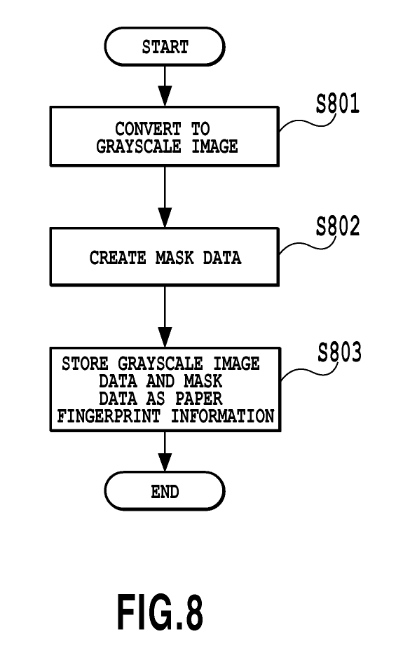

Now, description will be given of details of paper fingerprint information obtaining processing performed by the paper fingerprint information obtaining section 507. FIG. 8 is a flowchart showing the paper fingerprint information obtaining processing performed by the paper fingerprint information obtaining section 507.

Image data extracted by the paper fingerprint information obtaining section 507 is converted to grayscale image data in step S801.

In step S802, mask data to perform matching is created by removing, from an image converted to grayscale image data in step S801, printing and handwriting that can be factors for an erroneous determination. The mask data is binary data of “0” or “1.” For a pixel with a luminance signal value equal to or more than a first threshold value, that is, a bright pixel, the value of mask data is set to “1.” For a pixel with a luminance signal value less than a first threshold value, the value of mask data is set to “0.” The above processing is applied to each pixel contained in the grayscale image data.

In step S803, two pieces of the grayscale image data converted in step S801 and the mask data created in step S802 are stored as paper fingerprint information.

In the above, a description has been given of the paper fingerprint information obtaining processing performed by the paper fingerprint information obtaining section 507.

Description will be continuously given of an internal configuration of the scanner image processing section 312.

The paper fingerprint information obtaining section 507 transmits the paper fingerprint information of the abovementioned predetermined area to the RAM 302 by use of an unillustrated data bus. Moreover, the paper fingerprint information obtaining section 507 has a volatile or erasable nonvolatile memory. Therefore, the paper fingerprint information obtaining section 507 can be configured so as to not only obtain image data of a predetermined area in the input RGB image data but also store a page of RGB image data to be input or a part of the page. In such a configuration, a controller (such as a CPU or an ASIC) may be included besides the memory, so as to respond to a command from the CPU 301.

A code extracting section 508 detects existence of code image data if it exists in image data output from the masking processing section 501. The code extracting section 508 then decodes the detected code image data to extract information. The code extracting section 508 also has as a volatile or erasable nonvolatile memory as in the paper fingerprint information obtaining section 507. Therefore, the code extracting section 508 can be configured so as to not only detect existence of code image data if it exists in image data and decode the detected code image to extract information, but also store a page of RGB image data to be input or a part of the page.

Moreover, the paper fingerprint information obtaining section 507 and the code extracting section 508 include an unillustrated path to pass information decoded by the code extracting section 508 to the paper fingerprint information obtaining section 507. The information passed therethrough includes positional information to extract a paper fingerprint and paper fingerprint information to be described later. Further, when a paper fingerprint matching command is issued from CPU 301 to the paper fingerprint information obtaining section 507 and the code extracting section 508, the paper fingerprint information obtaining section 507 and the code extracting section 508 can return a paper fingerprint matching result to the CPU 301.

### <Printer Image Processing Section 315>

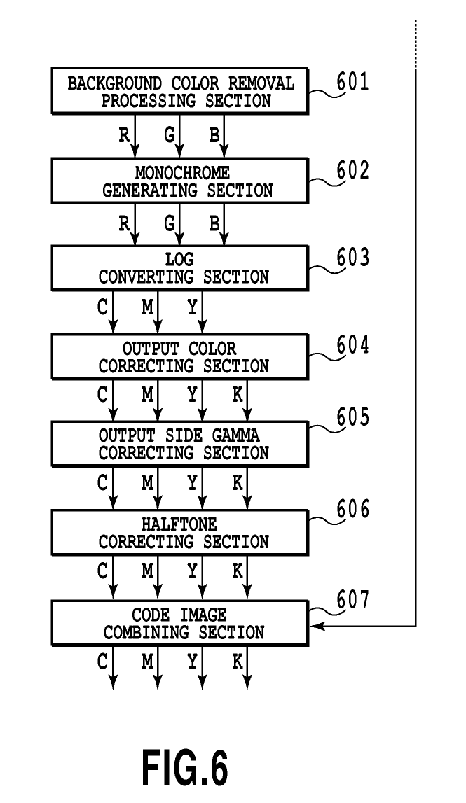

Here, description will be given of details of a process performed in the printer image processing section 315. FIG. 6 shows a flow of the processing performed in the printer image processing section 315.

A background color removal processing section 601 skips (i.e. removes) a background color of image data by use of the histogram generated by the scanner image processing section 312. A monochrome generating section 602 converts color data to monochrome data. A Log converting section 603 performs a luminance/density conversion. For example, the Log converting section 603 converts input RGB image data to CMY image data. An output color correcting section 604 performs an output color correction. For example, the output color correcting section 604 converts input CMY image data to CMYK image data using a predetermined conversion table or conversion matrix.

An output side gamma correcting section 605 performs correction so that a signal value input to the output side gamma correction section 605 is proportional to a density level after a copy output. A halftone correcting section 606 performs a halftone processing in accordance with the number of gray levels of the output printer section. For example, as for the received high gradient image data, it carries out digitization to two levels or 32 levels. A code image combining section 607 combines a document image corrected by the halftone correcting section 606 with a special code such as a two-dimensional barcode generated by the CPU 301 or generated by an unillustrated code image generating section.

In addition, the image to be combined is passed to the code image combining section 607 through an unillustrated path. The code image combining section 607 does not only combine a document image corrected by the halftone correcting section 606 with a code image to output it. The code image combining section 607 can also print a code image in time with discharging a document set on an unillustrated manual feed tray or a sheet of paper set on the cassette 203, 204, or 205 into the printer section 14. This function is mainly used in <Composition Examples of Code Image> and <Operation When Tab for Paper Fingerprint Information Registering Processing is Depressed> to be described later.

In the above, a description has been given of details of the processing performed in the printer image processing section 315.

In each processing section of the scanner image processing section 312 and the printer image processing section 315 described above, it is also possible to output received image data without applying each processing thereto. Passing data through a processing section without applying any processing thereto in this manner is expressed as “passing through the processing section.”

### <Paper Fingerprint Information Coding Processing>

Next, description will be given of a paper fingerprint information coding processing.

The CPU 301 is capable of controlling so as to read out paper fingerprint information of a predetermined area transmitted from the paper fingerprint information obtaining section 507 to the RAM 302 and encode the paper fingerprint information read out to generate code image data. In this specification, the code image means an image such as a two-dimensional code image and a barcode image.

Further, the CPU 301 is capable of controlling so as to transmit the generated code image data to the code image combining section 607 in the printer image processing section 315 via an unillustrated data bus.

The abovementioned control (that is, control to generate and transmit a code image) is performed by executing a predetermined program stored in the RAM 302.

### <Composition Examples of Code Image>

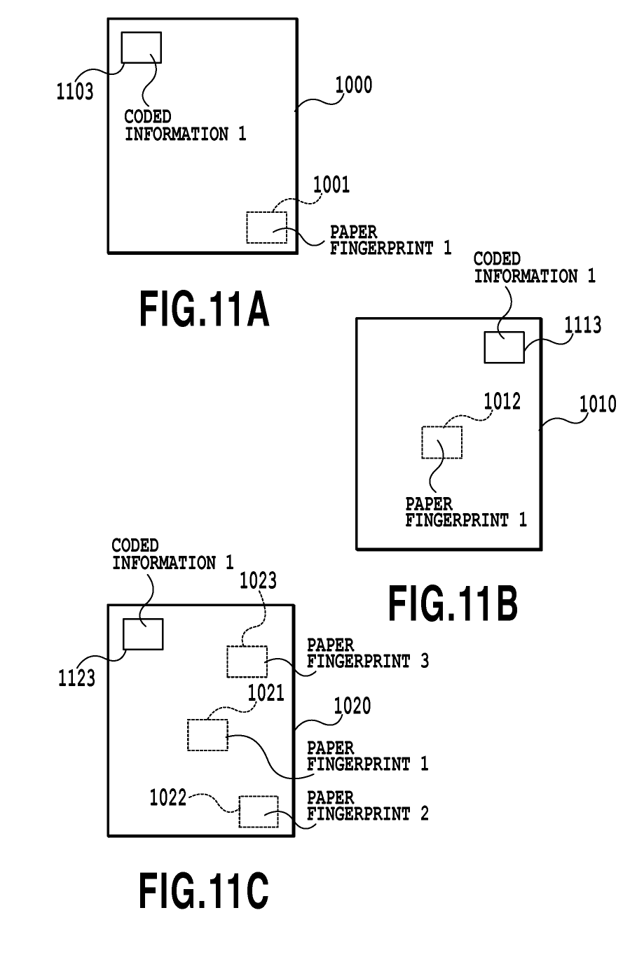

Here, composition examples of a code image (coded information) will be shown and described. FIG. 11A to FIG. 11C show composition examples of a code image.

In the case of, for example, a sheet of paper 1000 (FIG. 11A), a code image (coded information 1) is disposed in an area 1103. In the code image, paper fingerprint information of an area 1 denoted by a reference numeral 1001 and positional information of the paper area 1 denoted by reference numeral 1001 on the surface of the sheet are also added. At this time, the positional information may be combined separately from the code image. The code image may be either visible or invisible as long as it can be extracted by the code extracting section 508. The position of the code image 1103 also does not need to be at a specific position. Also, when the code image (coded information) is made invisible, a transparent toner, a less-visible ink such as yellow ink, or the like is used to perform printing so that the code image becomes hardly visible to human eyes, that is, hardly recognizable. The transparent toner and the like have been disclosed in Japanese Patent Laid-Open No. H07-123250, Japanese Patent Laid-Open No. 2007-11028, and the like.

In the case of a sheet of paper 1010 (FIG. 11B), a code image (coded information 1) is disposed in an area 1113. Likewise, positional information is added. Moreover, various conditions for the code image 1113 are the same as those in the case of code image 1103 mentioned above.

In the case of a sheet of paper 1020 (FIG. 11C), a code image (coded information 1) is disposed in an area 1123. In the code image, paper fingerprint information of an area 1 denoted by reference numeral 1021, an area 2 denoted by reference numeral 1022, and an area 3 denoted by reference numeral 1023 and positional information of the respective areas are also added.

At this time, for the purpose of correlating a paper fingerprint pick-up area to the position of a code image, an operator performs scanning to obtain paper fingerprint information in accordance with an instruction from the operating section. The operator then sets a sheet of paper, with instructed orientations such as front/back and portrait/landscape, on the paper cassette 203, 204, or 205 or unillustrated manual feed tray. Alternatively, an unillustrated reading device is installed in the course of conveyance of a sheet of paper from the paper cassette 203, 204, or 205 at the time of printing, and a paper fingerprint is picked up thereby to perform encoding. Then, the code image data and image data to be printed may be combined and printed.

### <Paper Fingerprint Information Matching Processing>

The CPU (central processing unit) 301 is capable of controlling so as to read out paper fingerprint information transmitted from the paper fingerprint information obtaining section 507 to the RAM 302 (first memory) and match the paper fingerprint information read out with other paper fingerprint information. Here, the other paper fingerprint information means paper fingerprint information included in the code image data.

Here, details of a paper fingerprint information matching processing will be described.

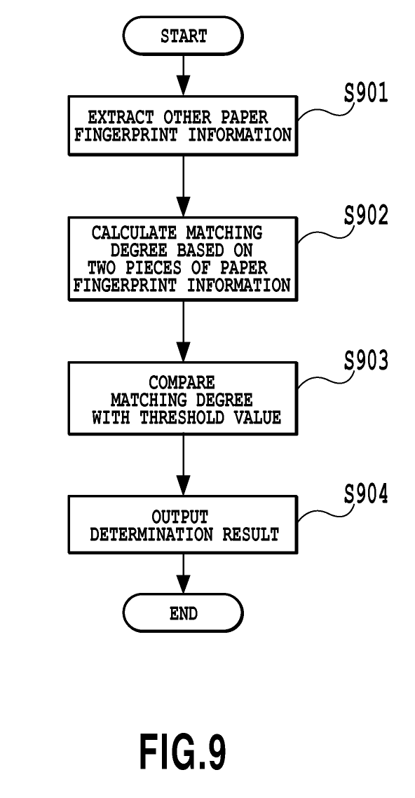

FIG. 9 is a flowchart showing the paper fingerprint matching processing. Respective steps of the flowchart are comprehensively controlled by the CPU 301.

In step S901, paper fingerprint information included in a code image (coded information) and paper fingerprint information recorded in a server (these are referred to as to-be-matched paper fingerprint information) are extracted from the RAM 302 (second memory). In this specification, “registering” means combining a code image (coded information) onto the surface of a sheet of paper or registering in a computer such as a server.

In step S902, for the purpose of matching paper fingerprint information transmitted from the paper fingerprint information obtaining section 507 with the paper fingerprint information extracted in step S901, the degree of matching, that is, a quantified matching level, of the two pieces of paper fingerprint information is calculated by use of formula (1). In the following, description will be given while referring to the paper fingerprint information transmitted from the paper fingerprint information obtaining section 507 as matching paper fingerprint information and referring to the paper fingerprint information extracted in step S901 as to-be-matched paper fingerprint information.

This calculation processing is for comparing and matching the matching paper fingerprint information and the to-be-matched paper fingerprint information. A function shown in formula (1) is used between the matching paper fingerprint information and the to-be-matched paper fingerprint information to perform a matching processing. Here, formula (1) represents a matching error.

$$E ( i , j ) = \frac{{\sum }_{x , y} {α}_{1} ( x , y ) {α}_{2} ( x - i , y - j ) {\{ {f}_{1} ( x , y ) - {f}_{2} ( x - i , y - j ) \}}^{2}}{{\sum }_{x , y} {α}_{1} ( x , y ) {α}_{2} ( x - i , y - j )}$$

In formula (1), α₁ is mask data in the paper fingerprint information (to-be-matched paper fingerprint information) read out in step S901. f₁(x,y) represents grayscale image data in the paper fingerprint information (to-be-matched paper fingerprint information) read out in step S901. On the other hand, α₂ is mask data in the paper fingerprint information (matching paper fingerprint information) transmitted from the paper fingerprint information obtaining section 507 in step S902. f₂(x,y) represents grayscale image data in the paper fingerprint information (matching paper fingerprint information) transmitted from the paper fingerprint information obtaining section 507 in step S902.

Moreover, (x,y) in formula (1) represents reference coordinates in the matching paper fingerprint information and the to-be-matched paper fingerprint information, and (i,j) represents parameters that take into consideration a displacement of the matching paper fingerprint information and the to-be-matched paper fingerprint information. In the present embodiment, however, the processing is performed with i=0 and j=0, regarding the displacement as negligible.

Now, for considering the meaning of the formula (1), consideration is given to a case where i=0, j=0, α₁(x,y)=1 (here, x=0˜n, y=0˜m), and α₂(x−i,y−j)=1 (here, x=0˜n, y=0˜m). In addition, n and m represent that the matching range is an area of n horizontal pixels and m vertical pixels. That is, E(0,0) when α₁(x,y)=1 (x=0˜n, y=0˜m) and α₂(x−i,y−j)=1 (x=0˜n, y=0˜m). In is to be determined.

Here, α₁(x,y)=1 (here, x=0˜n, y=0˜m) indicates that all pixels of read-out paper fingerprint information (to-be-matched paper fingerprint) are bright. In other words, when read-out paper fingerprint information (to-be-matched paper fingerprint) is obtained, this indicates that no color material such as toner or ink or dust has been placed on the paper fingerprint obtaining area.

Also, α₂(x−i,y−j)=1 (here, x=0˜n, y=0˜m) indicates that all pixels of paper fingerprint information (paper fingerprint information transmitted from the paper fingerprint information obtaining section 507 (matching paper fingerprint)) obtained this time are bright. In other words, when paper fingerprint information that has just been obtained is obtained, this indicates that no color material such as toner or ink or dust has been placed on the paper fingerprint obtaining area.

Thus, when α₁(x,y)=1 and α₂(x−i,y−j)=1 hold true in all pixels, formula (1) is expressed as:

$$E ( 0 , 0 ) = {\sum }_{x = 0 , y = 0}^{n , m} {\{ {f}_{1} ( x , y ) - {f}_{2} ( x , y ) \}}^{2}$$

{f₁(x,y)−f₂(x,y)}² in this formula represents a square value of a difference between the grayscale image data in the read-out paper fingerprint information (to-be-matched paper fingerprint information) and the grayscale image data in the paper fingerprint information (matching paper fingerprint information) transmitted from the paper fingerprint information obtaining section 507. Therefore, the formula (1) is equal to a sum of squares of differences between the two pieces of paper fingerprint information in the respective pixels. That is, the more pixels in which f₁(x,y) and f₂(x,y) are close exist, the smaller value E(0,0) takes.

### <Significance of α>

The numerator of formula (1) means a product of {f₁(x,y)−f₂(x−i,y−j)}² multiplied by α₁ and α₂ (more precisely, although omitted, a Σ symbol is further used to determine a summation). With regard to these α₁ and α₂, a pixel in a deep color indicates 0 and a pixel in a light color indicates 1. Therefore, when either one or both of α₁ and α₂ are 0, α₁α₂{f₁(x,y)−f₂(x−i,y−j)}² results in 0.

More specifically, when a target pixel is in a deep color in either one or both of the paper fingerprint information, a density difference in that pixel is not taken into consideration. This is for disregarding a pixel on which dust or a color material was placed. In this processing, since the number of squares to be summed increases or decreases depending on the Σ operation, the product is divided by a total number Σα₁(x,y)α₂(x−i,y−j) for normalizing.

In step S903, the degree of matching of the two pieces of fingerprint information determined in step S902 is compared with a predetermined threshold value (admissibility requirement) to determine whether being “effective” or “ineffective.”

In the above, a description has been given of matching that is performed based on a paper fingerprint obtained from one spot on the surface of a sheet of paper. As another mode, it is also possible to obtain a plurality of paper fingerprints from a plurality of spots on the surface of a sheet, compare the degrees of matching of information thereof and a plurality of pieces of to-be-matched paper fingerprint information corresponding thereto with a predetermined threshold value (admissibility requirement), and determine whether being “effective” or “ineffective” based on the number of matching degrees that have satisfied the admissibility requirement.

The controller 11 has been described in the above. In the following, description will be given of an operation screen.

### <Operation Screen>

FIG. 7 shows an initial screen in the operating section 12 of the image forming apparatus 10.

An area 701 is a display section of the operating section 12, and herein shown is whether the image forming apparatus 10 is ready to copy and the number of copies (in the illustrated example, “1”) that has been set. The document selecting tab 704 is for selecting the type of a document, and three types of selection menus of Text, Photograph, and Photograph/Text modes are pop-up displayed when the tab is depressed. An application mode tab 705 is for a setting of a reduction layout (that is, a function for reduced printing of a plurality of documents on one sheet of paper), a color balance (that is, a fine adjustment of respective CMYK colors), and the like. A finishing tab 706 is for a setting regarding various types of finishing. A Both Sides setting tab 707 is a tab for a setting regarding Both Sides reading and Both Sides printing.

A reading mode tab 702 is for selecting a reading mode of a document. Three types of selection menus of Color/Black/Auto (ACS) are pop-up displayed when the tab is depressed. Color copy is performed when the Color mode is selected, whereas monochrome copy is performed when the Black mode is selected. When the ACS mode is selected, the copy mode is determined by the monochrome/color determining signal described above. An area 708 is a tab for selecting a paper fingerprint information registering processing. Details of the paper fingerprint information registering processing will be described later. An area 709 is a tab for selecting a paper fingerprint information matching processing.

<Operation when Tab for Selecting Paper Fingerprint Information Matching Processing is Depressed>

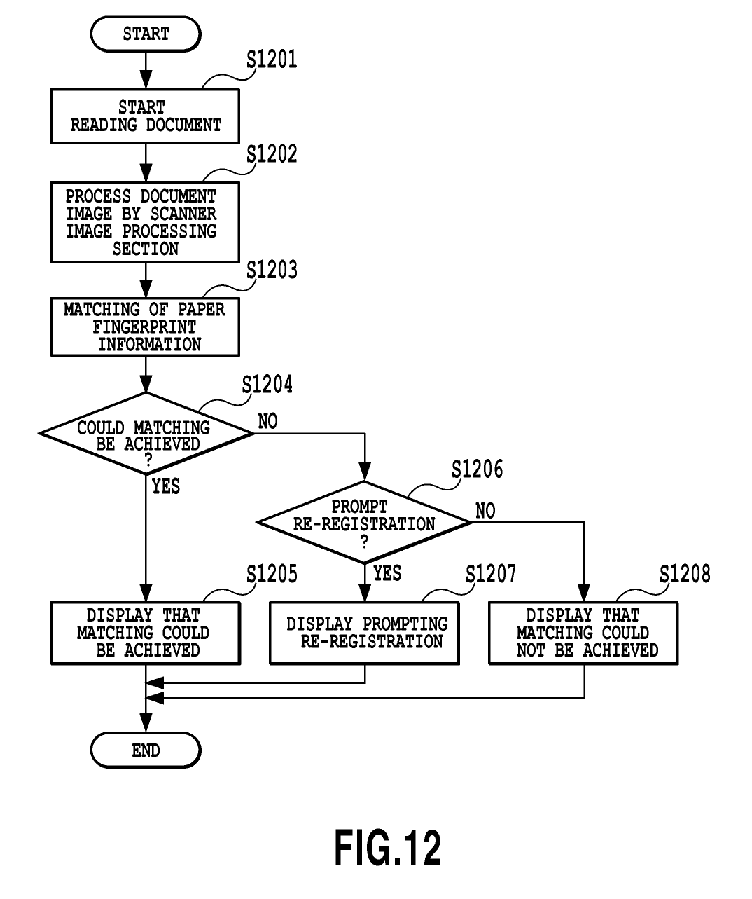

Here, a description will be given of an operation when an unillustrated start key is depressed after the paper fingerprint matching tab 709 shown in FIG. 7 is depressed by a user. FIG. 12 shows a flowchart for explaining this operation.

In step S1201, CPU 301 performs control so as to transmit, as image data, a document read by the scanner section 13 to the scanner image processing section 312 via the scanner I/F 311.

In step S1202, the scanner image processing section 312 applies, to the image data, the processing shown in FIG. 5 described above to generate attribute data along with new image data. In addition, the scanner image processing section 312 attaches the attribute data to the image data.

Further, the scanner image processing section 312 sets a gain control value smaller than the aforementioned common gain control value in the shading correcting section 500. The scanner image processing section 312 then outputs each luminance signal value obtained by applying the smaller gain control value to image data to the paper fingerprint information obtaining section 507. Then, based on the output data, the paper fingerprint information obtaining section 507 obtains paper fingerprint information. As for positioning in obtaining paper fingerprint information, when the position is in a predetermined fixed position on the surface of a sheet of paper, a paper fingerprint is obtained from that fixed position. On the other hand, when the position to obtain a paper fingerprint can be arbitrarily determined, the code extracting section 508 decodes the aforementioned coded information and determines the position to obtain paper fingerprint information based on positional information of a paper fingerprint included in the decoded information. Then, the code extracting section 508 transmits the obtained paper fingerprint information to the RAM 302 by use of an unillustrated data bus.

Further, in the step S1202, if a code image exists on the surface of a sheet of paper, the code extracting section 508 in the scanner image processing section 312 decodes the code image to obtain information, that is, decoded paper fingerprint data. Then, the code extracting section 508 transmits the obtained information to the RAM 302 by use of an unillustrated data bus.

In step S1203, the CPU 301 performs a paper fingerprint information matching processing. The paper fingerprint information matching processing is as has been described, in the section of <Paper Fingerprint Information Matching Processing> described above, by use of FIG. 9.

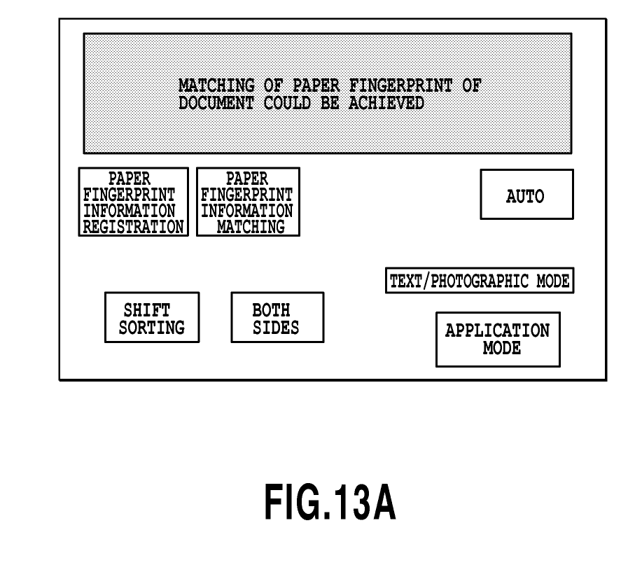

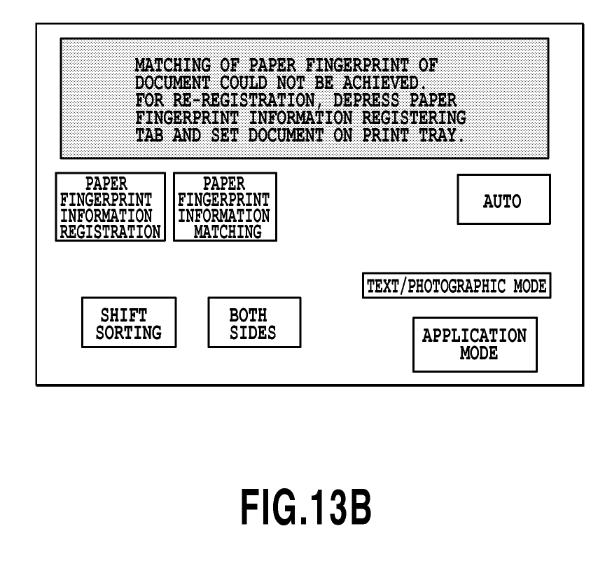

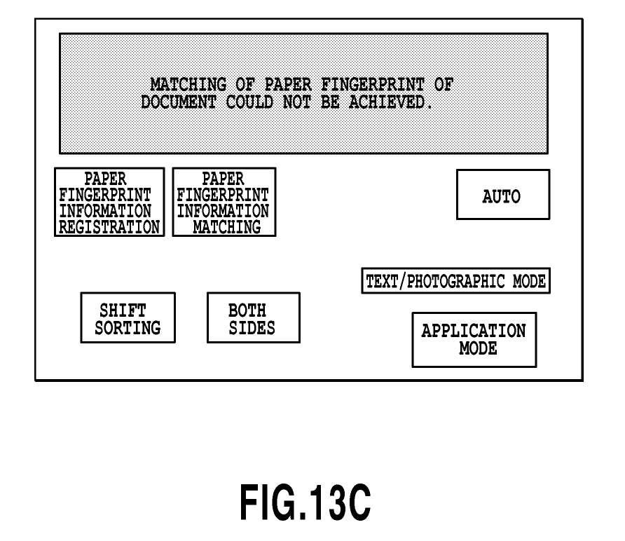

In step S1204, the CPU 301 judges whether matching could be achieved based on the result obtained by <Paper Fingerprint Information Matching Processing>. If it could be achieved, the fact that matching could be achieved is displayed on a display screen of the operating section 12 (see FIG. 13A). If it could not be achieved, the CPU 301 judges whether to prompt the user to perform a re-registration (re-registration promotion) in step S1206. As the judging method, the CPU 301 makes a judgment based on a difference between the degree of matching and a predetermined threshold value. And, for a confirmation whether to perform a re-registration, as a configuration of the re-registration promotion, the CPU 301 displays a confirmation message whether to perform a re-registration on the display screen of the operating section 12 in step S1207 (see FIG. 13B). At this time, for prevention of a re-registration from being performed by a third party except a user to register paper fingerprint, it is desirable to authenticate the user. The above is an ordinary flow. However, when the degree of matching is far below the threshold value, that is, when it satisfies an inadmissibility requirement, without displaying a message prompting a re-registration, the CPU 301 displays a message indicating that matching could not be achieved on the display screen of the operating section 12 in step S1208 (see FIG. 13C). As with the admissibility requirement, the inadmissibility requirement is preset.

<Operation when Tab for Paper Fingerprint Information Registering Processing is Depressed>

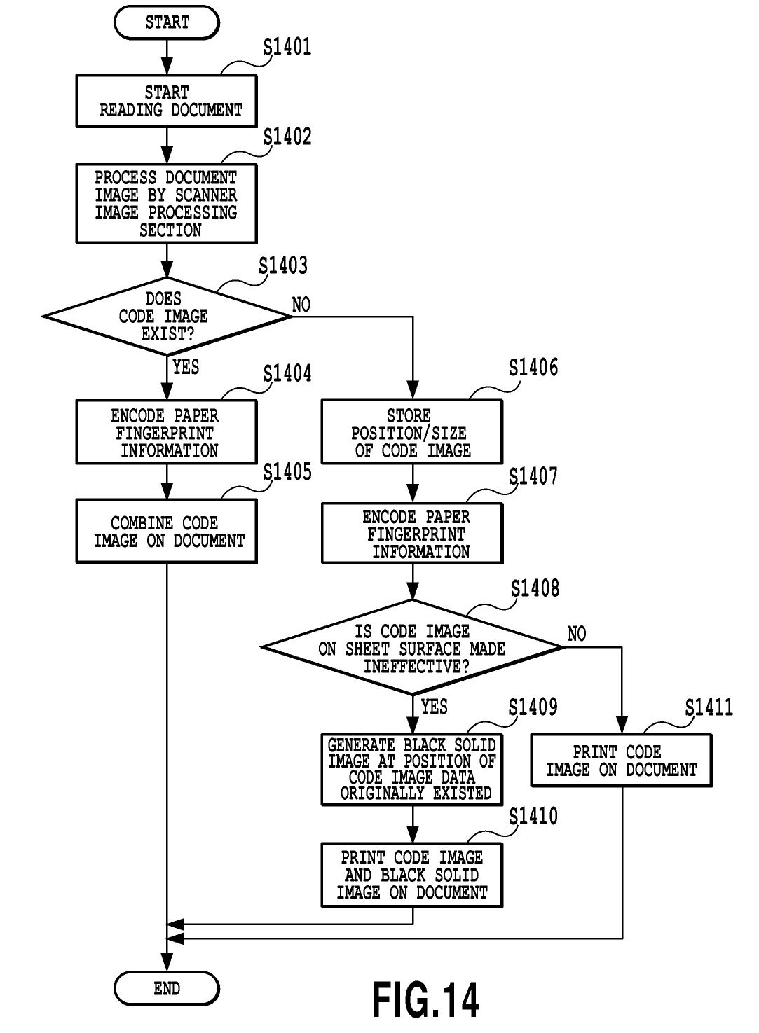

Next, referring to FIG. 14, description will be given of a paper fingerprint information registering processing that is executed when the start key is depressed after the paper fingerprint information registering tab 708 shown in FIG. 7 is depressed by a user.

In step S1401, the CPU 301 performs control so as to transmit, as image data, a document read by the scanner section 13 to the scanner image processing section 312 via the scanner I/F 311. The user places the document on a print tray after scanning ends. In step S1402, the scanner image processing section 312 applies, to the image data, the processing shown in FIG. 5 described above to generate attribute data along with image data. In addition, the scanner image processing section 312 attaches the attribute data to the image data.

Further, in the step S1402, the paper fingerprint information obtaining section 507 in the scanner image processing section 312 obtains paper fingerprint information. Here, the configuration for, for example, performing gain control of the shading correcting section 500 for the purpose of obtaining paper fingerprint information is as has been described above. Moreover, a paper fingerprint may be extracted from one spot or a plurality of spots. And, the paper fingerprint information obtaining section 507 transmits the obtained paper fingerprint information to the RAM 302 by use of an unillustrated data bus.

At this time, the area in which paper fingerprint information is obtained may be determined by previewing a document image on the operation screen or drawing an image drawing and letting an operator specify a position, or maybe determined at random. Alternatively, for example, a background color portion may be automatically determined from a signal level of the background color, or it is also possible to observe an edge amount or the like and automatically select an image area that is appropriate for obtaining paper fingerprint information therein.

The code extracting section 508 detects, in step S1403, whether a code image exists on the document. When no code image exists, the CPU 301 performs control in step S1404 so as to encode the paper fingerprint information obtained in step S1402 to generate code image data and transmit the generated code image data to the code image combining section 607 in the printer image processing section 315. The code image data includes positional information of the paper fingerprint obtained in step S1402.

In step S1405, the processing sections 601 to 606 in FIG. 6 are not input with an image. Here, only the image combining section 607 is made effective, and in time with output of the document set on the print tray to the printer section 14, the code image data generated in step S1404 is output by printing on the document.

When a code image is detected in step S1403, the CPU 301 stores a position and a size of the code image in step S1406.

In step S1407, the CPU 301 performs control so as to encode second paper fingerprint information obtained by the scanner image processing section to generate code image data and transmit the generated code image data to the code image combining section 607 in the printer image processing section 315. The code image data includes positional information of the paper fingerprint obtained in step S1402 and information on the position and size of the code image data obtained in step S1406. Here, the second paper fingerprint information may be obtained from the same position as with the code image detected by step S1403, or may be obtained from a different position.

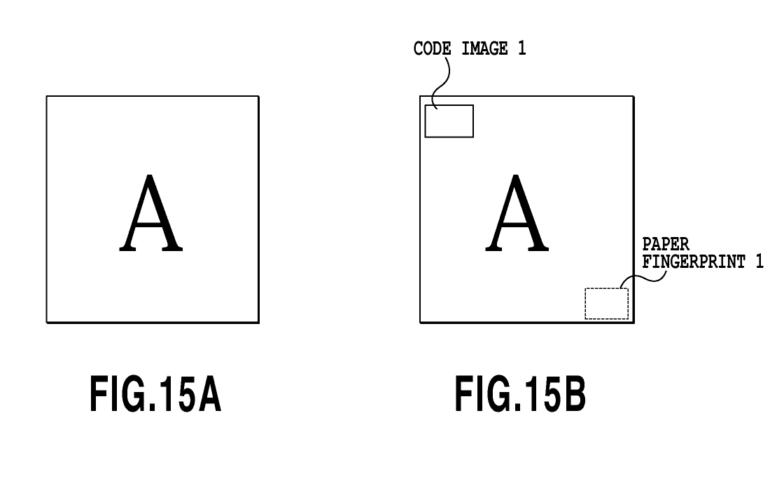

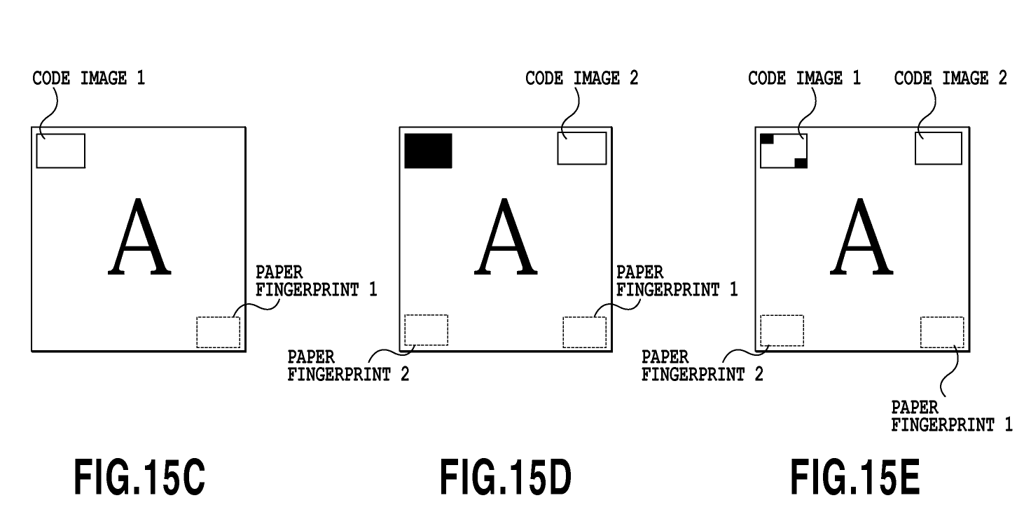

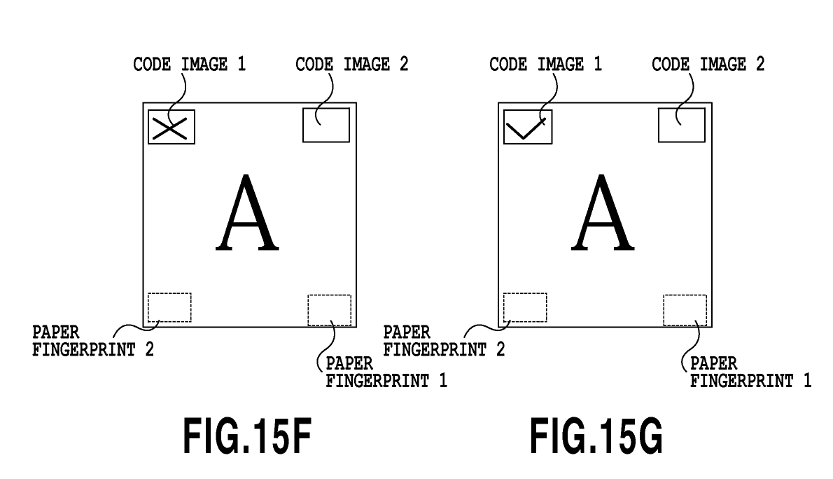

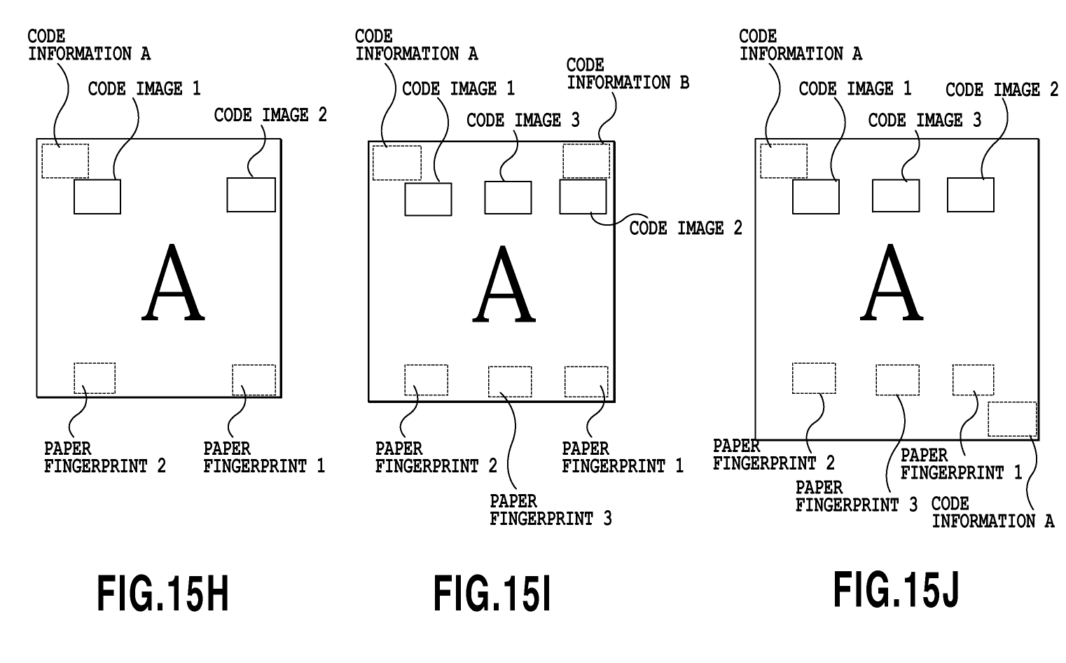

In step S1408, a display to receive an instruction whether to make the code image detected in step S1403 unextractable with the code extracting section from next time onward is carried out on the display screen of the operating section 12. When this is set to be unextractable by the user, in step S1409, the CPU 301 generates, at the position where the code image data exists stored in step S1406, a black solid image with the image combining section 327 and outputs the image to the printer image processing section 315. This is for the purpose of, by combining a black solid image with the code image data, making the code image data unreadable when the document is matched and thus eliminating an unnecessary code image reading processing, so as to prevent an increase in the overall processing time. Here, although the image to be combined is black solid, any image may be combined, even not black solid, as long as it can make the code image unextractable by the code extracting section. An example of the combining image to be combined onto the code image is shown in FIG. 15.

Now, returning to the point, in step S1410, only the black solid image generated in step S1409 is passed to the processing sections 601 to 606 in FIG. 6. Then, with conveyance of the document set on the print tray to the printer section 14 timed with an image formation, the black solid image and the code image data generated in step S1404 are printed on the document, and the document is output from the printer section 14.

At this time, the CPU 301 controls the position to print a code image on the document so that this is combined at a position different from the position of the code image detected in step S1406. In that case, it may be possible to let the user specify a combining position from the operating section 12 or automatically determine a combining position in a white-background part of the document based on the attribute data.

When it is set to be extractable by the user in step S1408, with conveyance of the document set on the print tray to the printer section 14 timed with an image formation, the code image data generated in step S1407 is printed on the document. Then, the document is output from the printer section 14. The position to print the code image on the document is determined as described in step S1410.

### <Examples of Document Input/Output by Registering Processing>

FIG. 15A to FIG. 15J show examples of a document input/output by the registering processing shown in FIG. 14. Here, mainly shown are methods for making a code image detected in step S1403 unextractable in next scanning.

FIG. 15A shows a document for which a paper fingerprint is not yet registered.

FIG. 15B shows a document for which a paper fingerprint is registered by the registering processing to the document of FIG. 15A shown in FIG. 14. In the case of this example, since no code image is detected in step S1403, the processing from step S1401 to step S1405 is performed. Here, a code image 1 for which a paper fingerprint 1 located at the lower right in the document and positional information of the paper fingerprint 1 are encoded is combined and output at the upper left in the document.

FIG. 15C shows a document for which a paper fingerprint is registered, and this is an example of a code image 1 for which a paper fingerprint 1 located at the lower right in the document and positional information of the paper fingerprint 1 are encoded is combined and output at the upper left in the document. FIG. 15D to FIG. 15G show various examples of a document for which a paper fingerprint is registered by the registering processing shown in FIG. 14 to the document shown in FIG. 15C.

When the document of FIG. 15C is scanned and applied with the registration processing, since a code image is detected in step S1403, the processing from step S1401 to step S1403 and from step S1406 to step S1410 is performed. In FIG. 15D, a code image 1 is filled with solid black in step S1409. Moreover, in this example, a code image 2 for which a paper fingerprint 2 located at the lower left in the document, positional information of the paper fingerprint 2, and positional and size information of the code image 1 are encoded is combined and output at the upper right in the document.

FIG. 15E, FIG. 15F, and FIG. 15G differ from FIG. 15D in only the combining image generated in step S1409. All of these are examples of a document for which a (or more) code image is made undeterminable by processing the code image. FIG. 15E shows an example where the method by which the code extracting section 508 detects a code image 1 is pattern matching, wherein patterns for code detection, that is, registration marks, exist at the upper left and lower right of the code image. In this example, only a pattern portion for pattern matching is made unreadable and undeterminable.

FIG. 15F and FIG. 15G show examples where the code extracting section 508 does not detect a code image when an arbitrary but predetermined mark exists in the code image 1, that is, when the code image 1 has been overwritten by a predetermined mark, and here, predetermined marks “x” and “v” are provided. These are mere exemplifications, and usable marks are not limited to these two marks, but any marks can be used as long as the code extracting section 508 thereby operates so as not to detect a code image.

FIG. 15H, FIG. 15I, and FIG. 15J respectively show examples of a method for not detecting an ineffective code image with the extracting section 508, which is different from the method for printing an image on a code image shown in FIG. 15D to FIG. 15G.

In code information A of FIG. 15H, encoded is information indicating which of code images 1 and 2 is effective. In this example, no such black solid image is printed or an arbitrary mark is printed on a code image so that the code extracting section 508 cannot extract a code as in FIG. 15D to FIG. 15G described above. In the present example, information indicating which of the code image 1 and the code image 2 is effective is obtained from code information A read in next scanning, and paper fingerprint information and a paper fingerprint obtaining position are obtained from the effective code image.

For FIG. 15I, a finger print in the document of FIG. 15H is re-registered, so that a code information B indicating which code image is effective is printed on the document. In the code information B of FIG. 15I, encoded is information indicating that a code image 3 is effective.

For FIG. 15J, code information A indicating which code image is effective is disposed at two diagonal corners of the document, so that, when the document is matched, the code information A is first reliably scanned in whichever direction the document is scanned. At the time of the matching/registering processing, by first extracting the code information A indicating which code image is effective in the code extracting section 508, and thereby first recognizing which code image is effective, the time until decoding the effective code image can be reduced.

Although, in FIG. 15H and FIG. 15J, which code image is effective has been distinguished with another code image, that is, the abovementioned code information, however, without limitation to such code information, it can be distinguished with a mark or the like indicating which code image is effective.

### Second Embodiment

<Operation for Re-Registration Processing Performed when Paper Fingerprint Matching Fails>

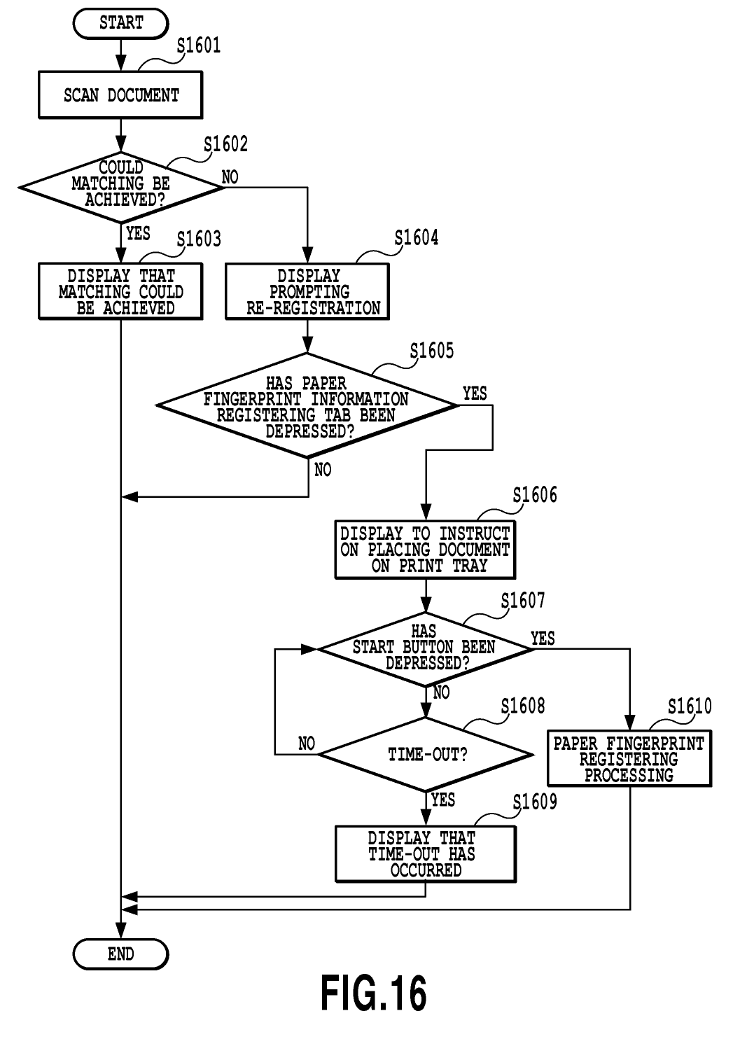

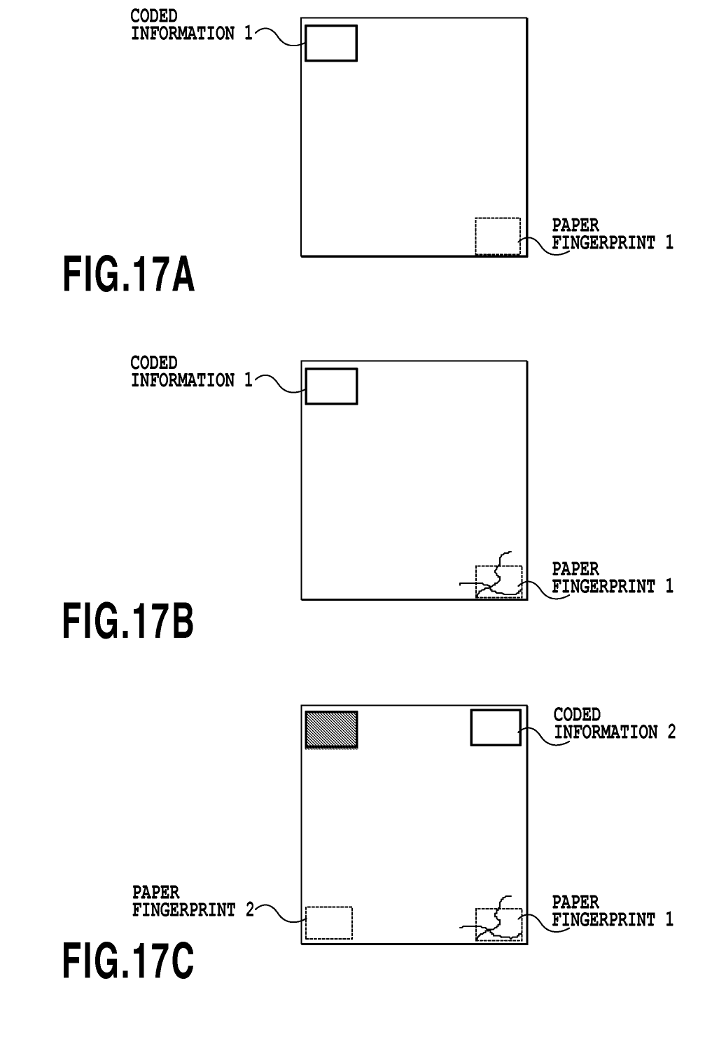

Referring to FIG. 16, description will be given of an operation flow when matching of a paper fingerprint is performed and cannot be achieved, and a user re-registers a paper fingerprint. Here, description will be given of the case where paper fingerprint matching is performed on the document of FIG. 17B, matching of the paper fingerprint cannot be achieved due to blotting and folding of the sheet of paper, and thus a re-registration is performed, and the document of FIG. 17C is output.

In step S1601, a document is scanned when the start key is depressed after the paper fingerprint information matching tab 709 (FIG. 7) is depressed by a user. An example of the document to be scanned is shown in FIG. 17B. This shows that a blot exists in a paper fingerprint 1. Here, the paper fingerprint information obtaining section 507 has, as has also been described in the above, a volatile or erasable nonvolatile memory, and stores a page of input RGB image data or a part of the page.

Whether matching of the paper fingerprint could be achieved is judged in step S1602. This corresponds, in the matching flow of FIG. 12, to the operation from step S1201 to step S1204. When matching could be achieved here, it is displayed in step S1603 that matching could be achieved, to inform a user of the fact. This corresponds, in the matching flow of FIG. 12, to the operation of step S1205.

On the other hand, when matching of the paper fingerprint could not be achieved in step S1602, a display prompting a re-registration is carried out in step S1604. This corresponds, in the matching flow of FIG. 12, to the operation of step S1206 and step S1207.

In step S1605, when the paper fingerprint information registering tab 708 is not depressed, the operation ends directly. When the paper fingerprint information registering tab 708 is depressed and a paper fingerprint is re-registered, a display to instruct on placing the document on the print tray is carried out on the display section of the operating section 12. When it is determined in step S1602 that matching of the paper fingerprint could not be achieved, the processing may shift to step S1606 omitting the operation of steps S1604 and S1605.

Next, in step S1607, when the start key is not depressed by the user, whether a set time has elapsed before the start key is depressed is monitored in step S1608. And, when the set time has elapsed, it is displayed in step S1609 that a time-out has occurred on the display section of the operating section 12, to prompt the user to execute the paper fingerprint information registering processing shown in FIG. 14.

On the other hand, when the unillustrated start key is depressed before a time-out occurs in step S1608, a registering processing of paper fingerprint information is executed in step S1610. At this time, image information (that is, image information of a corresponding page or a part of the page) to obtain paper fingerprint information in step S1601 exists in the memory. Therefore, step S1401 to step 1403 and step S1406 of the paper fingerprint registering processing flow shown in FIG. 14 can be omitted, and without executing these steps, the operation shifts to step S1407 to execute the subsequent processing. An example of the document thus registered and output is as in FIG. 17C.

In the present embodiment, the user can newly register paper fingerprint information, when matching of fingerprint information could not be achieved, without rescanning the document.

### Third Embodiment

<Processing Method when Matching Processing Command is Received>

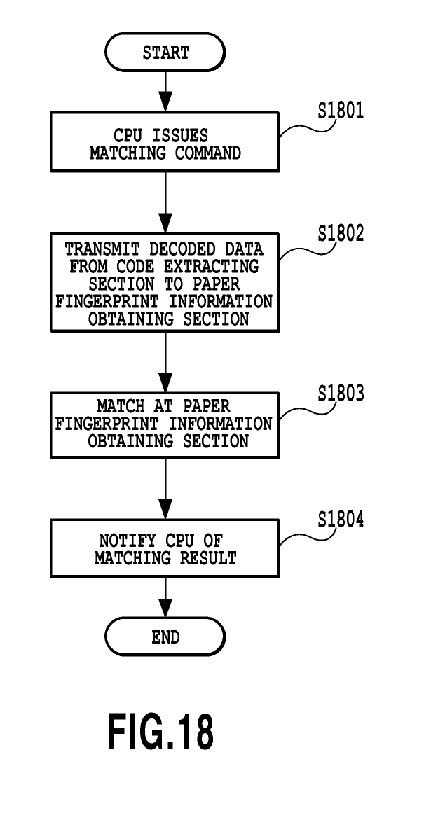

Referring to FIG. 18, description will be given for an example of a processing method when the paper fingerprint information obtaining section 507 and the code extracting section 508 have received a matching processing command from the CPU 301. This is an example of the case where the processing from step S1201 to step S1204 of FIG. 12 until the matching result is determined is performed by the paper fingerprint information obtaining section 507 and the code extracting section 508.

In step S1801, the CPU 301 issues a paper fingerprint matching command to the paper fingerprint information obtaining section 507 and the code extracting section 508 or either one of these. Here, the paper fingerprint information obtaining section 507 and the code extracting section 508 include, as described above, a volatile or erasable nonvolatile memory and a CPU, an ASIC, or the like.

In step S1802, the code extracting section 508 transmits decoded data (paper fingerprint information and extracting position information of the paper fingerprint information) decoded from code image data to the paper fingerprint information obtaining section 507.

Next, in step S1803, the paper fingerprint information obtaining section 507 recognizes positional information of the paper fingerprint from the decoded data received from the code extracting section 508 and obtains paper fingerprint information from a scanned sheet of paper. Then, the paper fingerprint information is matched with the paper fingerprint information obtained from the code extracting section 508.

In step S1804, the CPU 301 is notified of the matching result by an interruption. It is also possible to mount the paper fingerprint information obtaining section 507 and the code extracting section 508 on the same controller.

### Other Embodiments

As other embodiments of the present invention, the present invention can also be applied to a system composed of, for example, a plurality of devices (such as, for example, a computer, an interface device, a reader, and a printer) and an apparatus (such as a multifunction apparatus, a printer, or a facsimile apparatus) composed of a single device.

Moreover, the object of the present invention can also be achieved by a computer (or a CPU or an MPU) of the system or apparatus reading out, from a storage medium that stores a program code to realize the procedures of the flowcharts shown in the embodiments described above, the program code and executing the program code. In this case, the program code read out form the storage medium realizes the functions of the embodiments described above. Therefore, the program code and a computer-readable storage medium recorded or stored with the program code also constitute aspects of the present invention. That is, an image processing program also constitutes an aspect of the present invention.

As the recording medium for supplying the program code, for example, a floppy disk, a hard disk, an optical disk, a magnetooptical disk, a CD-ROM, a CD-R, a magnetic tape, a nonvolatile memory card, a ROM, or the like can be used.

Further, the functions of the embodiments described above can be realized by a computer executing a read-out program. This execution of a program includes the case where an OS or the like running on the computer performs a part or all of actual processing based on an instruction of the program.

Further, the functions of the embodiments described above can also be realized by a function extension board inserted in a computer or a function extension unit connected to a computer. In this case, first, a program read out from a storage medium is written in a memory equipped in the function extension board inserted in a computer or the function extension unit connected to a computer. Then, based on an instruction of the program, a CPU or the like equipped in the function extension board or the function extension unit performs a part of all of actual processing. The functions of the embodiments described above can also be realized by such a processing by the function extension board or the function extension unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-117740, filed Apr. 26, 2007, which is hereby incorporated by reference herein in its entirety.

What is claimed is:

1. An image processing apparatus comprising:
an extracting means that extracts a paper fingerprint of a sheet surface and coded information on the paper fingerprint;
a decoding means that decodes the coded information extracted by the extracting means;
a matching means that matches paper fingerprint data decoded by the decoding means with data of the extracted paper fingerprint; and
a re-registration prompting means that performs a display operation to prompt a re-registration based on a result of matching by the matching means.

2. The image processing apparatus as claimed in claim 1, wherein the matching means makes a judgment for matching, based on a matching level obtained by quantifying a degree of matching between paper fingerprint data decoded by the decoding means and data of a fingerprint extracted by the extracting means.

3. The image processing apparatus as claimed in claim 1, wherein the re-registration prompting means does not prompt a re-registration when the matching level satisfies a preset admissibility requirement.

4. The image processing apparatus as claimed in claim 1, wherein the re-registration prompting means prompts a re-registration when the matching level does not satisfy a preset admissibility requirement.

5. The image processing apparatus as claimed in claim 1, wherein the re-registration prompting means does not prompt a re-registration when the matching level satisfies a preset inadmissibility requirement.

6. The image processing apparatus as claimed in claim 1, wherein the coded information includes information on a paper fingerprint and positional information of the paper fingerprint on the sheet surface.

7. The image processing apparatus as claimed in claim 1, wherein the coded information includes data of a plurality of paper fingerprints.

8. The image processing apparatus as claimed in claim 1, wherein the matching means makes a judgment for matching, based on a number of matching levels obtained by respectively quantifying degrees of matching between a plurality of paper fingerprint data decoded by the decoding means and data of a plurality of fingerprints extracted by the extracting means, that satisfy a preset admissibility requirement.

9. The image processing apparatus as claimed in claim 1, wherein the matching means includes:
a storing means that stores data of the extracted paper fingerprint in a first memory;
a storing means that stores the extracted coded information in a second memory; and
a decoding means that decodes the coded information stored in the second memory, and the matching means matches paper fingerprint data stored in the first memory with the decoded paper fingerprint data, and outputs a matching result.

10. The image processing apparatus as claimed in claim 1, wherein the matching means includes:
a storing means that stores the extracted coded information in a second memory; and
a decoding means that decodes the coded information stored in the second memory, and the matching means transmits paper fingerprint data decoded by the decoding means and data of the extracted paper fingerprint to a central processing unit, and performs matching by the central processing unit.

11. An image processing apparatus comprising:
an extracting means that extracts a paper fingerprint of a sheet surface and coded information on the paper fingerprint;
an adding means that adds the coded information to the sheet surface;
a registering means that registers a second paper fingerprint and second coded information different from a first paper fingerprint and first coded information; and
a processing means that processes the first coded information so as to make the first coded information undeterminable in response to registration by the registering means is performed.

12. The image processing apparatus as claimed in claim 11, wherein the processing means makes the coded information undeterminable by processing the first coded information.

13. The image processing apparatus as claimed in claim 11, wherein the coded information includes information on a paper fingerprint and positional information of the paper fingerprint on the sheet surface.

14. The image processing apparatus as claimed in claim 11, wherein the coded information includes data of a plurality of paper fingerprints.

15. The image processing apparatus as claimed in claim 11, wherein the second paper fingerprint is obtained from a different position on the sheet surface from that of the first paper fingerprint.

16. The image processing apparatus as claimed in claim 11, wherein the second paper fingerprint is obtained from the same position on the sheet surface as that of the first paper fingerprint.

17. The image processing apparatus as claimed in claim 11, wherein the first and second coded information include data of a plurality of paper fingerprints, respectively.

18. The image processing apparatus as claimed in claim 11, wherein the registering means includes:
a storing means that stores image information of a sheet of paper in a first memory when a paper fingerprint is extracted by the extracting means; and
an obtaining means that obtains a second paper fingerprint from the image information of a sheet of paper stored in the first memory, and the registering means registers coded information on the obtained second paper fingerprint.

19. The image processing apparatus as claimed in claim 11, wherein the registering means registers the second coded information in a different place from that of the first coded information.

20. The image processing apparatus as claimed in claim 11, wherein, when the registering means that registers the second paper fingerprint and the second coded information performs registration and the means that makes the first coded information undeterminable makes the coded information undeterminable, the second paper fingerprint and the second coded information become the first paper fingerprint and the first coded information.

21. An image processing method comprising the steps of:
extracting a paper fingerprint of a sheet surface and coded information on the paper fingerprint;
decoding the coded information extracted in the extracting step;
matching paper fingerprint data decoded in the decoding step with data of the extracted paper fingerprint; and
prompting a re-registration by performing a display operation to prompt a re-registration based on a result of matching in the matching step.

22. An image processing method comprising the steps of:
extracting a paper fingerprint of a sheet surface and coded information on the paper fingerprint;
adding the coded information to the sheet surface;
registering a second paper fingerprint and second coded information different from a first paper fingerprint and first coded information; and
processing the first coded information so as to make the first coded information undeterminable in response to registration is performed in the registering step.

23. An image processing program comprising the steps of:
extracting a paper fingerprint of a sheet surface and coded information on the paper fingerprint;
decoding the coded information extracted in the extracting step;
matching paper fingerprint data decoded in the decoding step with data of the extracted paper fingerprint; and
prompting a re-registration by performing a display operation to prompt a re-registration based on a result of matching in the matching step.
